(19) United States
(12) Patent Application Publication
(10) Pub. No.: US 2010/0099073 A1
(43) Pub. Date: Apr. 22, 2010

(54) Combination chalkboard and corkboard

(76) Inventors: Michele L. Howard, Frisco, TX (US); Jon G. Howard, Frisco, TX (US)

Correspondence Address: LITMAN LAW OFFICES, LTD., POST OFFICE BOX 41200, SOUTH STATION, ARLINGTON, VA, 22204, US

(21) Appl. No.: 12/289,208

(22) Filed: Oct. 22, 2008

(51) Int. Cl. B43L 1/04

(52) U.S. Cl. 434/408

(57) ABSTRACT

The combination chalkboard and corkboard is a display, both for erasable writing thereon with chalk and for removable attachment thereto of paper and the like via pushpins or thumbtacks. The combination chalkboard and corkboard includes a frame, a cork layer, and a mesh layer. The cork and mesh layers may be held together by the frame. The mesh layer is at least partially exposed through the frame so that the mesh may be marked by chalk. Apertures formed through the mesh layer and the cork layer are adapted for receiving pushpins.

### BACKGROUND OF THE INVENTION

1. Field of the Invention

The present invention relates to displays and message boards, and more particularly to a combination chalkboard and corkboard that provides a display surface upon which the user can write with chalk, and which also receives pushpins, thumbtacks or the like in a manner typically associated with corkboards.

2. Description of the Related Art

Message-type display boards are well known in the art. Conventional bulletin boards, for example, are typically made from a cork or other tack penetrable material, and are used to pin or tack notes or signs to the display surface. Other typical message boards include dry-erase boards, permanent signage, illuminated displays and chalkboards. Conventional message boards typically only include a single function; i.e., a conventional chalkboard, for example, cannot be written upon with a dry erase marker or receive thumbtacks. Thus, the user must obtain and display multiple message boards in order to provide the functionality of each type of display. It would be desirable to provide a display having multiple functionality. Thus, a combination chalkboard and corkboard solving the aforementioned problems is desired.

### SUMMARY OF THE INVENTION

The combination chalkboard and corkboard is a display, allowing for erasable writing thereon with chalk, and the removable attachment thereto of paper and the like via pushpins or thumbtacks. The combination chalkboard and corkboard includes a frame, a cork layer having opposed upper and lower surfaces, and a mesh layer having opposed upper and lower surfaces. The lower surface of the mesh layer is positioned above the upper surface of the cork layer, and the cork and mesh layers are held together by the frame. The upper surface of the mesh layer is at least partially exposed through the frame such that it may be marked by chalk. Apertures formed through the mesh layer and the upper surface of the cork layer are adapted for receiving pushpins.

Additionally, a backing layer, having opposed upper and lower surfaces, may be further provided. The upper surface thereof is positioned below the lower surface of the cork layer, and the cork, mesh and backing layers are all held together by the frame. Further, a batting layer may be sandwiched between the upper surface of the cork layer and the lower surface of the mesh layer.

These and other features of the present invention will become readily apparent upon further review of the following specification and drawings.

### BRIEF DESCRIPTION OF THE DRAWINGS

FIG. 1 is an environmental front view of a combination chalkboard and corkboard according to the present invention.

FIG. 2 is an exploded, perspective view of the combination chalkboard and corkboard according to the present invention.

FIG. 3 is a partial, side view in section of the combination chalkboard and corkboard according to the present invention.

Similar reference characters denote corresponding features consistently throughout the attached drawings.

### DETAILED DESCRIPTION OF THE PREFERRED EMBODIMENTS

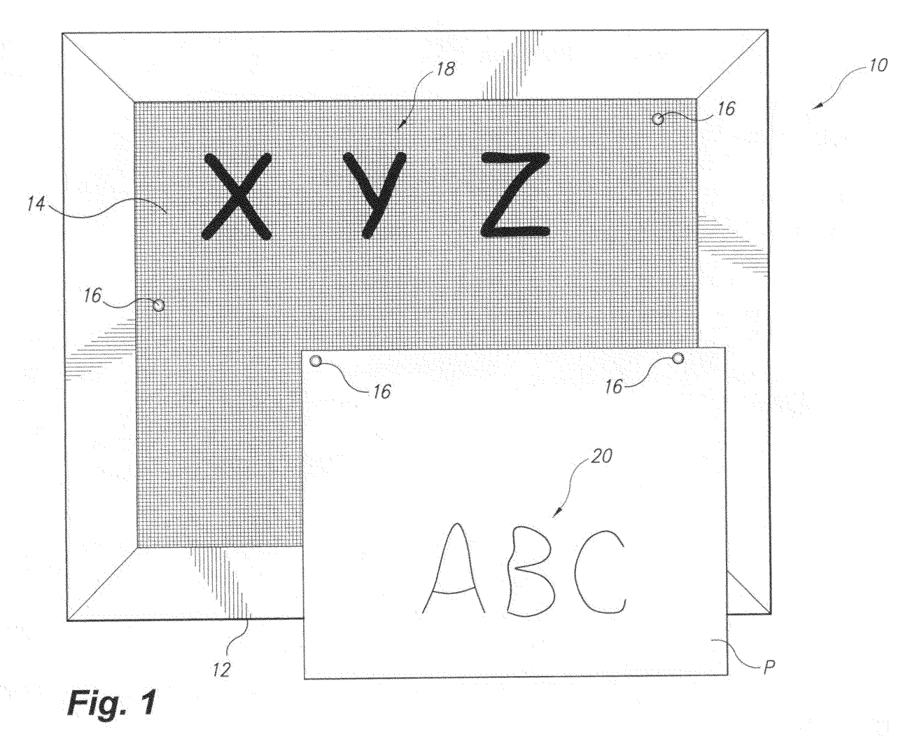

As shown in FIG. 1, the combination chalkboard and corkboard 10 is a display, both for erasable writing thereon with chalk (such as exemplary chalk markings 18) and for removable attachment thereto of paper and the like (such as paper P with imprinting 20 formed thereon) via pushpins or thumbtacks 16.

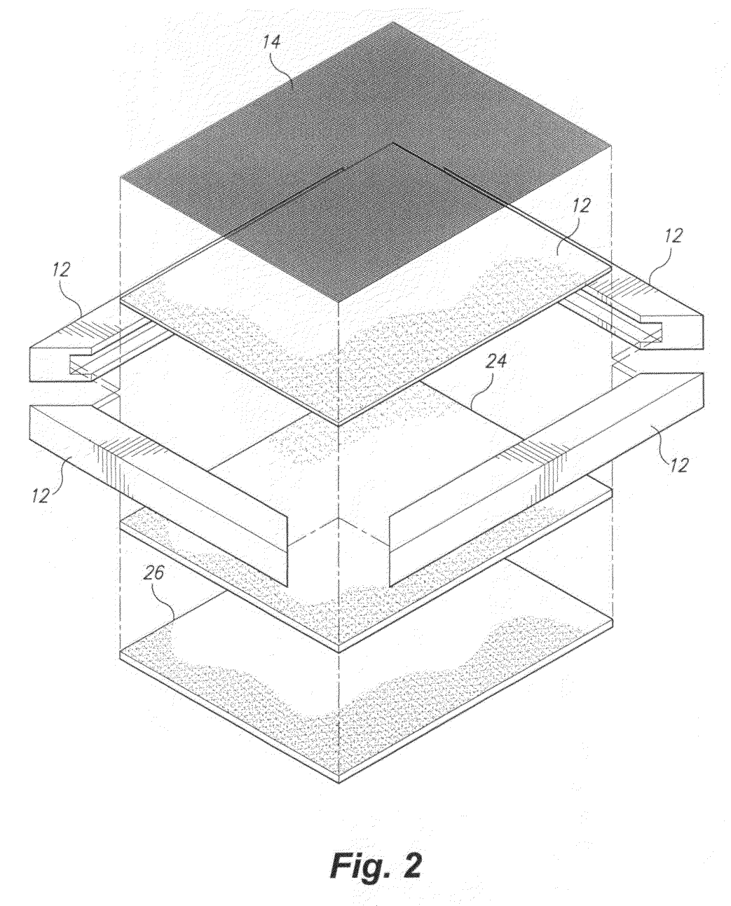

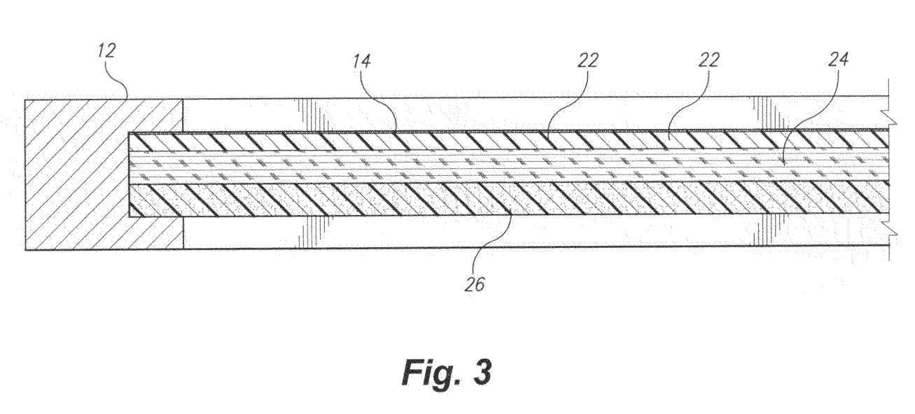

As best shown in FIGS. 2 and 3, the combination chalkboard and corkboard 10 includes a backing layer 26, which is formed from a substantially rigid material, such as wood or foam, with a cork layer 24 being mounted thereon. It should be understood that layer 24 is not limited to being formed from cork. Layer 24 is formed from any suitable material for holding a pushpin, thumbtack or the like, such as foam, or a combination of foam and cork, as is conventionally known in bulletin board type displays. Layer 24 is preferably at least ½ an inch in thickness, in order to accommodate conventional pushpins or thumbtacks.

Mesh layer 14 is positioned above cork layer 24, and layers 14, 24 and 26 are received within, and held by, frame 12. As shown, a layer of polyester batting 22 or the like may be positioned between the mesh layer 14 and the cork layer 24. Frame 12 may be any suitable frame and may have any desired dimension or configuration. Frame 12 may be formed from wood, metal, plastic or any other suitable material, and may include ornamental features. The layers 14, 22, 24 and 26 may be held within frame 12 through the use of any suitable fastener, such as adhesive, nails, staples, screws, or the like, or by frictional engagement. Alternatively, layers 14, 22, 24 and 26 may be held together via adhesive or the like without the use of an external frame.

Mesh layer 14 may be any suitable mesh having openings or apertures formed therethrough capable of receiving and holding the pin of a pushpin, thumbtack or the like (such a exemplary pushpins 16), and which is further formed from a material upon which erasable markings can be made with chalk. Such mesh materials are often marketed as sun shade or solar shade mesh screens, and can be formed from polyvinyl chloride (PVC) coated polyester, fiberglass, nylon, PVC, aramids, steel (which would allow for a ferromagnetic surface), aluminum or the like. It should be understood that any suitable mesh material may be utilized.

Layers 14, 22, 24 and 26 may be held together within frame 12 through the application of additional adhesive layers or the like. As noted above, layer 24 is preferably at least ½ an inch in thickness, in order to accommodate conventional pushpins. Alternatively, backing layer 26 could be formed from foam or a similar material, capable of receiving the pin of a pushpin, and the combination of layer 24 and layer 26 would then preferably be at least ½ an inch in thickness.

As a further alternative, the layer 26 could be removed, and the mesh screen 14 would be placed on the layer 22, as in the previous embodiment, which is preferably formed from polyester batting or soft foam, and these layers are then supported on cork layer 24 alone. In this alternative, the batting layer 22 is preferably approximately ¼ of an inch in thickness, and the cork layer 24 is preferably approximately ½ of an inch in thickness. The polyester batting or soft foam of layer 22 acts to reduce the possibility of deformation of mesh screen 14 during writing, and further acts as a noise and vibration damper when mesh screen 14 is being written upon. As a further alternative, an additional layer of thin fabric material may be sandwiched between the polyester batting layer 22 and the mesh screen 14 in order to protect the polyester fibers of layer 22 from projecting through the apertures of mesh screen 14.

It is to be understood that the present invention is not limited to the embodiments described above, but encompasses any and all embodiments within the scope of the following claims.

We claim:

1. A combination chalkboard and corkboard, comprising:
a frame;
a cork layer; and
a mesh layer, the cork and the mesh layers being held together by the frame;
wherein the mesh layer is at least partially exposed through the frame so that the mesh layer may be marked by chalk, the mesh layer and the cork layer being adapted for inserting pushpins through the mesh to lodge in the cork.

2. The combination chalkboard and corkboard as recited in claim 1, further comprising a backing layer adjacent said cork layer on a side of said cork layer opposite said mesh layer, wherein said cork, said mesh, and said backing layers are held together by said frame.

3. The combination chalkboard and corkboard as recited in claim 2, wherein said backing layer is formed from foam.

4. The combination chalkboard and corkboard as recited in claim 2, further comprising a batting layer sandwiched between said cork layer and said mesh layer.

5. The combination chalkboard and corkboard as recited in claim 1, further comprising a batting layer sandwiched between said cork layer and said mesh layer.

6. A combination chalkboard and corkboard, comprising:
a frame;
a pin-receiving layer; and
a mesh layer, the pin-receiving layer and the mesh layer being held together by the frame;
wherein the mesh layer is at least partially exposed through the frame, the mesh layer being adapted for being marked by chalk, the mesh layer and the pin-receiving layer being adapted for inserting pins through the mesh to lodge in the pin-receiving layer.

7. The combination chalkboard and corkboard as recited in claim 6, wherein said pin-receiving layer comprises a layer of cork.

8. The combination chalkboard and corkboard as recited in claim 7, further comprising a backing layer adjacent said cork layer on a side of said cork layer opposite said mesh layer, wherein said cork layer, said mesh layer, and said backing layer are held together by said frame.

9. The combination chalkboard and corkboard as recited in claim 8, wherein said backing layer is formed from foam.

10. The combination chalkboard and corkboard as recited in claim 8, further comprising a batting layer sandwiched between said cork layer and said mesh layer.

11. The combination chalkboard and corkboard as recited in claim 6, further comprising a backing layer adjacent said pin-receiving layer on a side of said pin-receiving layer opposite said mesh layer, wherein said pin-receiving layer, said mesh layer, and said backing layer are held together by said frame.

12. The combination chalkboard and corkboard as recited in claim 11, wherein said backing layer is formed from foam.

13. The combination chalkboard and corkboard as recited in claim 6, further comprising a batting layer sandwiched between said pin-receiving layer and said mesh layer.

14. A combination chalkboard and corkboard, comprising:
a cork layer; and
a mesh layer, the cork and the mesh layers being held together;
wherein an external surface of the mesh layer is adapted for marking by chalk, the mesh layer and the cork layer being adapted for inserting pushpins through the mesh to lodge in the cork.

15. The combination chalkboard and corkboard as recited in claim 14, further comprising a backing layer attached to said cork layer on a side of said cork layer opposite said mesh layer.

16. The combination chalkboard and corkboard as recited in claim 15, wherein said backing layer is formed from foam.

17. The combination chalkboard and corkboard as recited in claim 15, further comprising a batting layer sandwiched between said cork layer and said mesh layer.

18. The combination chalkboard and corkboard as recited in claim 17, further comprising a frame, wherein said cork layer, said mesh layer, said batting layer and said backing layer are held together by said frame.

19. A combination chalkboard and corkboard according to claim 14, wherein said cork layer and said mesh layer are joined together by adhesive.
